(19) United States
(12) Patent Application Publication
(10) Pub. No.: US 2012/0320327 A1
(43) Pub. Date: Dec. 20, 2012

(54) VARIABLE WIDTH SEAL

(76) Inventors: Young-Bae PARK, San Jose, CA (US); Steven J. MARTISAUSKAS, San Francisco, CA (US); Joshua G. WURZEL, Sunnyvale, CA (US); Shih Chang CHANG, Cupertino, CA (US); John Z. ZHONG, Cupertino, CA (US)

(21) Appl. No.: 13/163,507

(22) Filed: Jun. 17, 2011

(51) Int. Cl. G02F 1/1339; B32B 37/00; B32B 17/00; B31B 1/62

(52) U.S. Cl. 349/153; 156/60; 156/64; 428/426

(57) ABSTRACT

Forming a seal between plates (e.g., glass plates within an LCD or electrodes within an OLED display) using a non-uniform pattern of adhesive applied between the plates is disclosed. The pattern of adhesive can include more adhesive material in portions of the plate that are expected to experience higher levels of stress. The pattern of adhesive can be determined based at least in part on the width of the surface of the plates that contact each other, where wider and narrower portions of the surface can have different adhesive patterns. The amount of adhesive applied to the plates can be varied by adjusting the speed at which a dispensing nozzle traverses the contact surface of the plate, the flow rate at which adhesive is dispensed from the nozzle, or both.

### FIELD

This relates generally to displays, such as liquid crystal displays (LCDs) and organic light-emitting diode (OLED) displays. More specifically, this relates to forming a seal between glass plates within an LCD or electrodes within an OLED display.

### BACKGROUND

Conventional LCDs operate by projecting light through a layer of liquid crystals and applying varying amounts of electrical charge to the liquid crystals in order to change the color and intensity of the display. Typically, the layer of liquid crystals is contained within a small gap formed between two glass plates that are held together by a uniform strip of adhesive, such as an epoxy or other appropriate sealant, applied along the edges of the plates.

While a uniform application of adhesive may be sufficient to hold the glass plates together under normal operation, shock, for example, caused by the device being hit against another object or by the device being dropped on the ground, may cause the plates to separate. This separation often occurs at the corners of the device since these regions typically experience the greatest amount of stress when pressure is applied to the plates.

Since the layer of liquid crystals is held in place by the glass plates, it is important that a proper seal be maintained between the plates. If the seal breaks, the liquid crystals may leak, rendering the device inoperable. Thus, it is desirable to form a strong seal between the glass plates enclosing the layer of liquid crystals.

### SUMMARY

This relates to forming a seal between plates (e.g., glass plates within an LCD or electrodes within an OLED display) using a non-uniform pattern of adhesive material. The pattern of adhesive can be applied between the plates and can include more adhesive material in portions of the plate that are expected to experience higher levels of stress. In some embodiments, the pattern of adhesive can be determined based at least in part on the width of the surface of the plates that contact each other, where wider and narrower portions of the contact surface can have different adhesive patterns. This can advantageously prevent the plates from separating, or at least reduce the chance that the plates separate, when pressure is applied to the plates, for example, when the device is hit or dropped.

In some embodiments, the amount of adhesive applied to the plates can be varied by adjusting the speed at which a dispensing nozzle traverses the contact surface of the plate. In some embodiments, the amount of adhesive applied can be varied by adjusting the flow rate at which adhesive is dispensed from the nozzle. In some embodiments, the amount of adhesive applied can be varied by adjusting both the dispensing nozzle speed and the adhesive dispensing flow rate. This can advantageously be used to adjust the amount of adhesive applied to select portions of the plate without altering the path of the nozzle.

### BRIEF DESCRIPTION OF THE DRAWINGS

FIG. 1 illustrates a cross-sectional view of an exemplary LCD according to various embodiments.

FIG. 2 illustrates a top-view of an exemplary glass plate according to various embodiments.

FIG. 3 illustrates a top-view of an exemplary pattern of adhesive applied to a glass plate according to various embodiments.

FIG. 4 illustrates a top-view of another exemplary pattern of adhesive applied to a glass plate according to various embodiments.

FIG. 5 illustrates a top-view of another exemplary pattern of adhesive applied to a glass plate according to various embodiments.

FIG. 6 illustrates an exemplary process for creating a seal between two plates.

FIG. 7 illustrates an exemplary computing system that can be used to implement processing functionality according to various embodiments.

### DETAILED DESCRIPTION

In the following description of example embodiments, reference is made to the accompanying drawings in which it is shown by way of illustration specific embodiments that can be practiced. It is to be understood that other embodiments can be used and structural changes can be made without departing from the scope of the various embodiments.

This relates to forming a seal between plates (e.g., glass plates within an LCD or electrodes within an OLED display) using a non-uniform pattern of adhesive material. The pattern of adhesive can be applied between the plates and can include more adhesive material in portions of the plate that are expected to experience higher levels of stress. In some embodiments, more adhesive material can be applied at the plate corners than at other portions of the plates. In some embodiments, the pattern of adhesive can be determined based at least in part on the width of the surface of the plates that contact each other, where wider and narrower portions of the contact surface can have different adhesive patterns. This can advantageously prevent the plates from separating, or at least reduce the chance that the plates separate when pressure is applied to the plates, for example, when the device is hit or dropped.

In some embodiments, the amount of adhesive applied to the plates can be varied by adjusting the speed at which a dispensing nozzle traverses the contact surface of the plate. In some embodiments, the amount of adhesive applied can be varied by adjusting the flow rate at which adhesive is dispensed from the nozzle. In some embodiments, the amount of adhesive applied can be varied by adjusting both the dispensing nozzle speed and the adhesive dispensing flow rate. This can advantageously be used to adjust the amount of adhesive applied to select portions of the plate without altering the path of the nozzle.

In some embodiments, a non-uniform pattern of adhesive can be applied to one or more of the glass plates that enclose a layer of liquid crystals in an LCD to prevent the plates from separating and the liquid crystals leaking out. In other embodiments, a non-uniform pattern of adhesive can be applied to one or more of the electrodes that enclose the organic materials of an OLED display to prevent the electrodes from separating and the organic material leaking out. These will be described in more detail below.

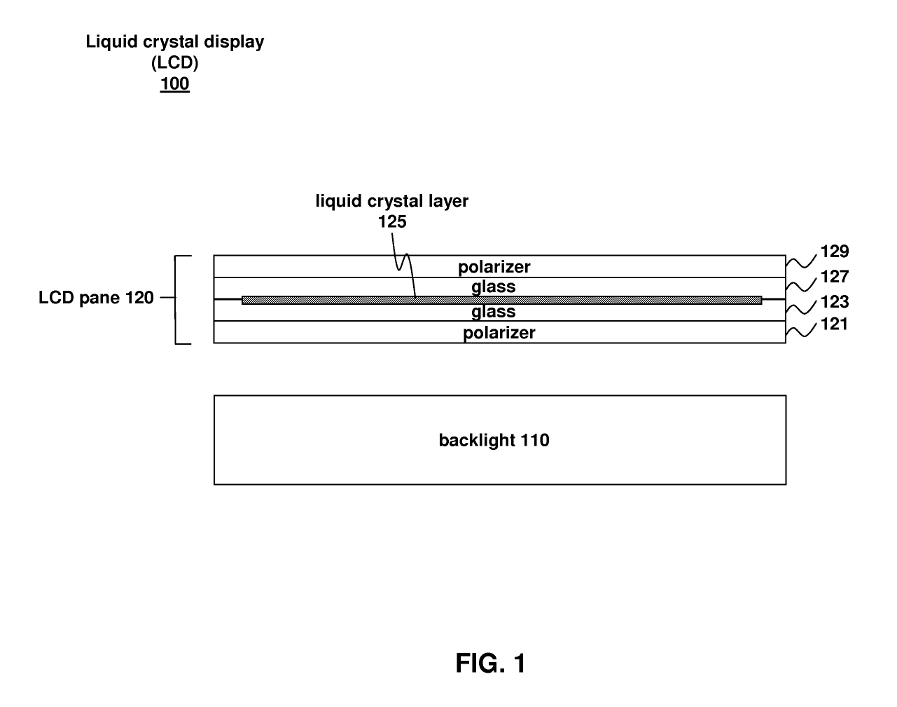

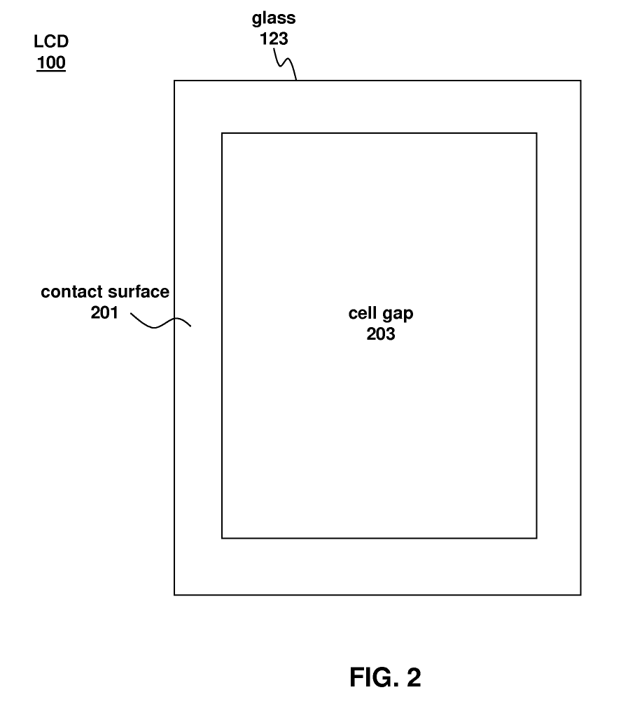

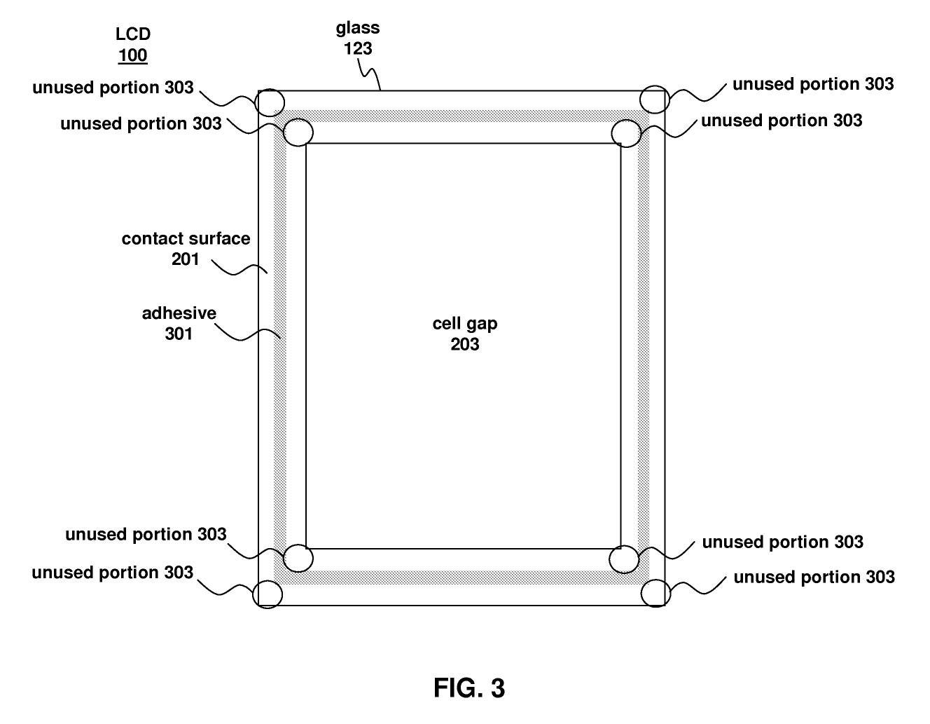

FIG. 1 illustrates a cross-sectional view of a block diagram of an exemplary liquid crystal display (LCD) 100. In the example shown in FIG. 1, LCD 100 can include backlight 110 for projecting light through the LCD crystals contained in LCD pane 120. LCD 100 can further include LCD pane 120 for controlling the transmittance of light from backlight 110 to the front of the display. LCD pane 120 can include a pair of polarizers 121 and 129 for filtering the light from backlight 110 and a layer of liquid crystals 125 contained in a cell gap formed between glass plates 123 and 127. As will be discussed in greater detail below with respect to FIGS. 2 and 3, glass plates 123 and 127 can be glued together along their edges using an adhesive, such as an epoxy or other appropriate sealant.

While specific embodiments of LCD 100 have been described above, it should be appreciated that other devices may likewise be used, including but not limited to, OLED displays, multi-domain vertical alignment, patterned vertical alignment, in-plane switching, and super-twisted nematic type LCDs. Thus, it should be appreciated that the principals of generating a non-uniform pattern of adhesive can be similarly applied to these types of displays.

FIG. 2 illustrates a top-view of LCD 100 showing the various regions of glass plate 123. In some embodiments, glass plate 127 can include features similar to glass plate 123, but can be inverted relative to glass plate 123 when arranged as shown in FIG. 1. Glass plate 123 can include a contact surface 201 representing the portion of glass plate 123 that contacts glass plate 127 when arranged as shown in FIG. 1. When placed against glass plate 127, contact surface 201 and the corresponding contact surface of glass plate 127 can form an enclosure surrounding cell gap 203. Cell gap 203 can represent the portion of glass plate 123 that holds liquid crystal layer 125. The portion of glass plate 123 corresponding to cell gap 203 can be recessed relative to contact surface 201. Thus, when glass plate 123 is placed against glass plate 127, cell gap 203 of glass plate 123 and the cell gap of glass plate 127 can form a hollow region that can be used to hold liquid crystal layer 125.

FIG. 3 illustrates a top view of LCD 100 showing the application of an adhesive 301 to glass plate 123. Adhesive 301 can be used to hold glass plate 123 together with glass plate 127. In doing so, adhesive 301 can form a seal along contact surface 201 to hold the liquid crystals of liquid crystal layer 125 within cell gap 203. Adhesive 301 can include any adhesive, such as an epoxy or other appropriate sealant material. In the illustrated example, adhesive 301 can include a uniform strip of adhesive applied along the center of contact surface 201. This can provide uniform seal strength along contact surface 201. However, when pressure is applied to glass plates 123 and 127, the separation stress can be non-uniform along contact surface 201. In some examples, higher levels of stress can be experienced in the corners of glass plates 123 and 127.

As shown in FIG. 3, the uniform pattern of adhesive 301 can form unused portions 303 of contact surface 201 near the corners of glass plate 123. Unused portions 303 can represent the portions of contact surface 201 that are not covered with adhesive 301, and thus represent portions of contact surface 201 that are not being utilized to form a seal around cell gap 203. These portions can be formed when using the pattern of adhesive shown in FIG. 3 because a uniform strip of adhesive is being applied to a contact surface 201 having a non-uniform width, where the width between an inner edge of contact surface 201 and an outer edge of contact surface 201 is shorter than a width between an inner corner of contact surface 201 and an outer corner of contact surface 201. As will be described in greater detail below, additional adhesive can be applied to unused portions 303 to increase the seal strength at these locations without adding additional bulk to LCD 100.

To increase the strength of the seal formed between glass plate 123 and glass plate 127, a non-uniform pattern of adhesive according to various embodiments can be used to hold glass 123 together with glass plate 127, thereby providing increased seal strength in portions of contact surface 201 that are likely to experience higher levels of stress.

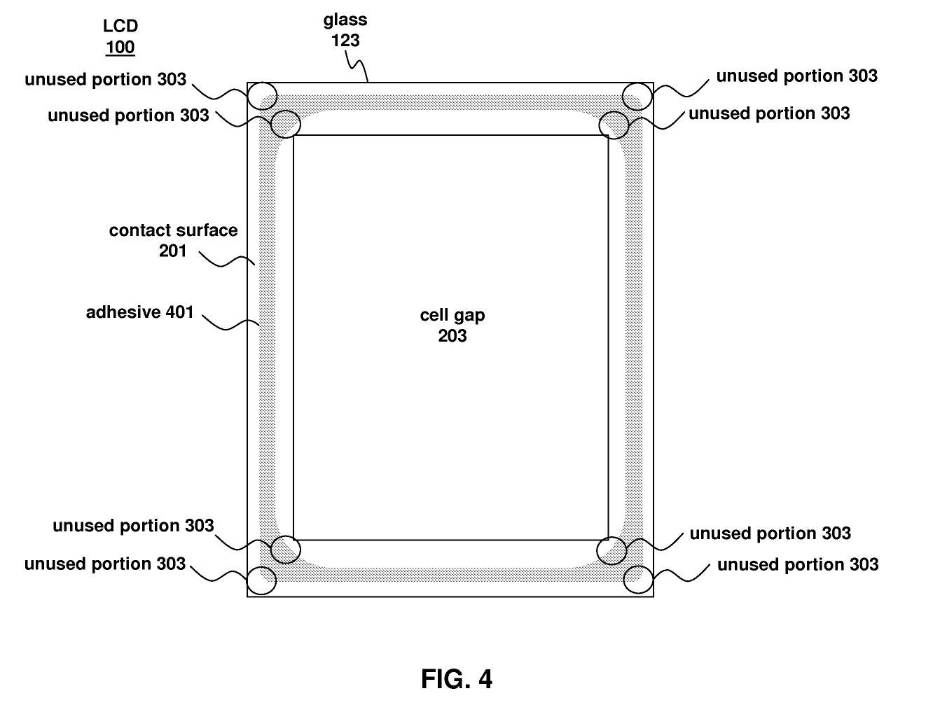

FIG. 4 illustrates a top-view of LCD 100 showing the application of a non-uniform pattern of adhesive 401 to glass plate 123. Adhesive 401 can include a similar adhesive material as adhesive 301, such as an epoxy or other appropriate sealant. However, the distribution of adhesive 401 along contact surface 201 can be non-uniform. Specifically, a larger amount of adhesive material can be placed near the corners of contact surface 201 to at least partially fill the unused portions 303 of contact surface 201 that are formed when using the uniform pattern of adhesive 301 shown in FIG. 3. By applying additional amounts of adhesive 401 near the corners of contact surface 201, a stronger seal can be formed in portions of contact surface 201 that are likely to experience a greater amount of stress when pressure is applied to glass plates 123 and 127, for example, when LCD 100 is hit or dropped.

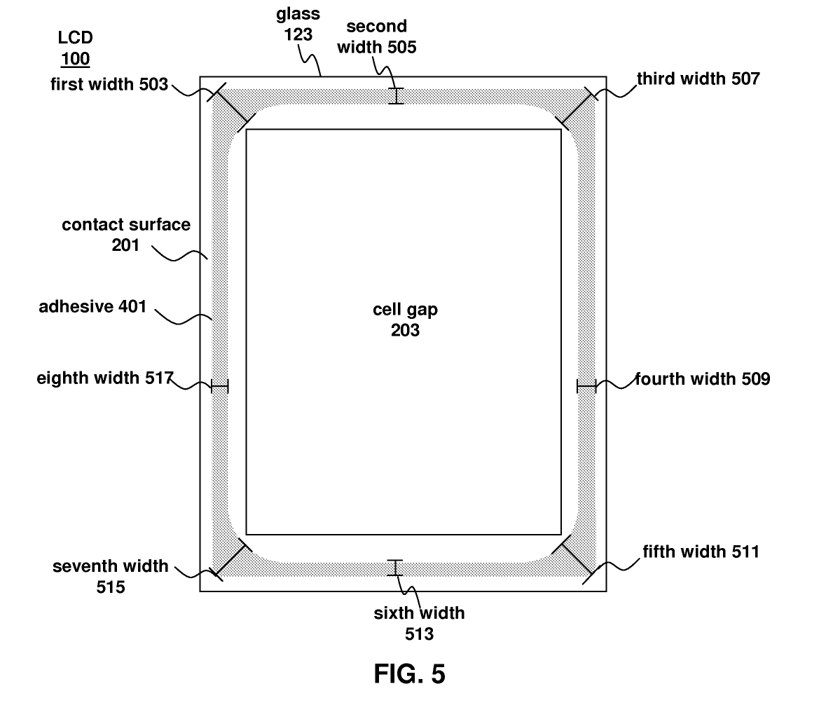

In some embodiments, as shown in FIG. 5, the non-uniform pattern of adhesive 401 can have widths 503, 505, 507, 509, 511, 513, 515, and 517, corresponding to each segment (corners and edges) of the pattern of adhesive 401. In some embodiments, the adhesive can be applied to contact surface 201 of glass plate 123 so as to have the illustrated widths before glass plate 127 is placed against it. In some embodiments, the adhesive can be applied so as to produce the illustrated widths after glass plate 123 and glass plate 127 have been placed against each other, thereby causing the adhesive material to spread across contact surface 201.

In some embodiments, edge widths 505, 509, 513, and 517, corresponding to the adhesive segments along the edges of contact surface 201, can be equal, or at least substantially equal (e.g., within 100 μm due to manufacturing tolerances). Additionally, in these embodiments, corner widths 503, 507, 511, and 515, corresponding to the adhesive segments at the corners of glass plate 123, can be equal, or at least substantially equal (e.g., within 100 μm due to manufacturing tolerances). In these embodiments, corner adhesive widths 503, 507, 511, and 515 can be 100% or more wider than edge adhesive widths 505, 509, 513, and 517. However, it should be appreciated that the relative sizes of corner adhesive widths 503, 507, 511, and 515 and edge adhesive widths 505, 509, 513, and 517 can depend on the glass geometry of the specific application.

In other embodiments, some or all of edge adhesive widths 505, 509, 513, and 517 can be the same or different. Similarly, some or all of corner adhesive widths 503, 507, 511, and 515 can be the same or different. In these embodiments, the widths 503, 505, 507, 509, 511, 513, 515, and 517 can be determined based at least in part on the width of contact surface 201 at that location. For example, edges of adhesive 401 can extend to 200 μm or less from the edges of contact surface 201 at that location. The width of contact surface 201 can be measured by measuring the distance from an inner edge of contact surface 201 to an outer edge of contact surface 201. For corners of contact surface 201, the width can be measured from the inner corner of contact surface 201 to the corresponding outer corner of contact surface 201.

In some embodiments, adhesive 401 can be deposited on contact surface 201 such that the edges of adhesive 401 are at most 200 μm from the edge of contact surface 201. In other embodiments, a scribe-on-seal technique can be used to pattern epoxy along the edge of contact surface 201. In these embodiments, the epoxy can extend to the edge of contact surface 201 where it can be cured after glass plate 127 is positioned on glass plate 123.

While the examples above describe applying adhesive to glass plate 123, it should be appreciated that adhesive may alternatively be applied to glass plate 127 or can be applied to both glass plates 123 and 127 to produce the patterns of adhesive described above. Additionally, while the examples above were described with respect to a rectangular glass plate, it should be appreciated that the concepts of applying additional adhesive to wider portions of a contact surface or portions that are likely to experience a greater amount of stress can be similarly applied to plates of other shapes, such as circles, squares, triangles, and the like. Moreover, while the examples show a continuous pattern of adhesive material applied to the glass plates 123 and 127, a pattern of discrete segments of adhesive material can be applied to form a broken pattern on the contact surface 201, where some of the segments can be wider than other portions according to the likelihood of stress at the corresponding contact surface portions.

To form the pattern of adhesive material applied to the contact surface of the glass plates, the amount of adhesive material applied can vary, where more adhesive can be applied to form wider patterns and less adhesive can be applied to form narrower patterns, as described below.

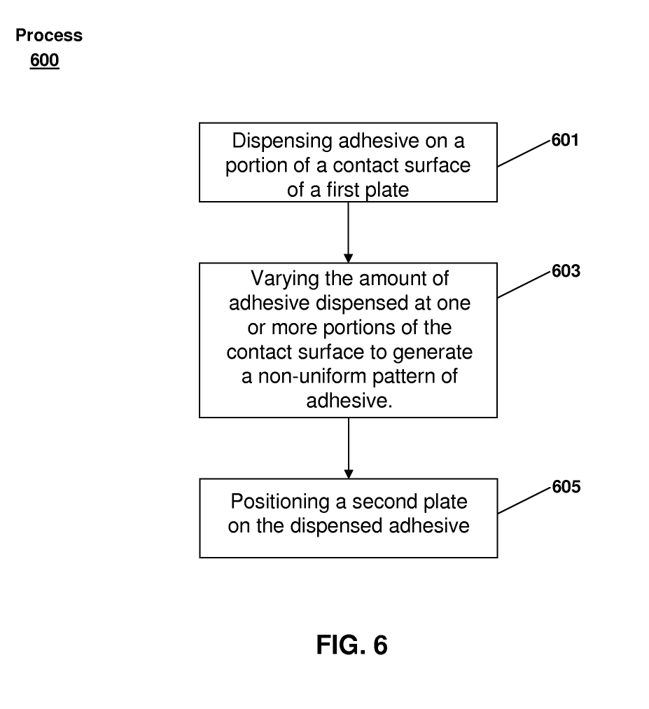

FIG. 6 illustrates exemplary process 600 for creating a seal between two plates. In some embodiments, exemplary process 600 can be performed using an automated adhesive dispensing nozzle operable to dispense an adhesive on a plate by traversing the desired adhesive pattern on the plate while simultaneously dispensing the adhesive material. The automated adhesive dispensing nozzle can be controlled using a computing system similar or identical to computing system 700 described below. In other embodiments, exemplary process 600 can be performed manually.

At block 601, adhesive can be dispensed on a portion of a contact surface of a first plate. In some embodiments, the adhesive, such as an epoxy or other appropriate sealant, can be applied to a portion of the plate that is to contact a contact surface of a second plate. For example, an adhesive that is similar or identical to adhesive 401 can be applied to a contact surface that is similar or identical to contact surface 201 of a glass plate that is similar or identical to glass plate 123. In other embodiments, adhesive can be applied to a contact surface of an electrode of an OLED display.

At block 603, the amount of adhesive dispensed at one or more portions of the contact surface can be varied to generate a non-uniform pattern of adhesive. In some embodiments, the amount, or volume, of adhesive dispensed at a particular location of the contact surface can be varied by adjusting the speed (distance per unit time) at which the nozzle traverses the contact surface of the plate. For instance, if the speed of the nozzle is increased, the amount of time that the nozzle remains over a particular location of the plate is decreased, thereby reducing the amount of adhesive applied to the plate. Similarly, if the speed of the nozzle is decreased, the amount of time that the nozzle remains over a particular location of the plate is increased, thereby increasing the amount of adhesive applied to the plate. For example, the speed of the nozzle at corners of a glass plate, as illustrated in FIGS. 4 and 5, can be decreased, thereby increasing the amount of adhesive applied at the corners over the amount applied elsewhere. The speed of the nozzle at the corners of an electrode can similarly be decreased, thereby increasing the amount of adhesive applied at the corners over the amount applied elsewhere.

In other embodiments, the amount of adhesive dispensed at a particular location of the contact surface can be varied by adjusting the flow rate (e.g., volume of adhesive dispensed per unit time) at which adhesive is dispensed from the nozzle. For instance, if the flow rate at which the adhesive is dispensed from the nozzle is increased, the amount of adhesive applied to the locations of the contact surface corresponding to the locations of the nozzle during the period of increased flow rate is also increased. Similarly, if the flow rate at which the adhesive is dispensed from the nozzle is decreased, the amount of adhesive applied to the locations of the contact surface corresponding to the locations of the nozzle during the period of decreased flow rate is also decreased. For example, the adhesive flow rate at corners of a glass plate, as illustrated in FIGS. 4 and 5, can be increased, thereby increasing the amount of adhesive applied at the corners over the amount applied elsewhere. The adhesive flow rate at the corners of an electrode can similarly be increased, thereby increasing the amount of adhesive applied at the corners over the amount applied elsewhere.

In yet other embodiments, the amount of adhesive dispensed at a particular location of the contact surface can be varied by adjusting both the speed at which the nozzle traverses the contact surface of the plate and the flow rate at which adhesive is dispensed from the nozzle. For instance, both the speed and flow rate of the nozzle can be increased, both the speed and flow rate of the nozzle can be decreased, or one of the speed and flow rate of the nozzle can be increased while the other is decreased. For example, the speed of the dispensing nozzle can be decreased and the adhesive flow rate increased at corners of a glass plate, as illustrated in FIGS. 4 and 5, thereby increasing the amount of adhesive applied at the corners over the amount applied elsewhere. Similarly, the speed of the dispensing nozzle can be decreased and the adhesive flow can be increased at the corners of an electrode, thereby increasing the amount of adhesive applied at the corners over the amount applied elsewhere.

By varying the speed and flow rate of the nozzle in this way, the amount of adhesive dispensed at different locations on a plate can be changed without having to change the path of the nozzle. For instance, a non-uniform pattern of adhesive, such as that shown in FIGS. 4 and 5, can be generated by traversing, with the nozzle, a continuous rectangular path that follows the shape of contact surface 201 in a single pass. In some embodiments, the continuous rectangular path can follow the center of contact surface 201 that is formed by the midpoints between the inner and outer edges of contact surface 201. This avoids having to form patterns (e.g., back and forth patterns or triangle patterns) of adhesive in areas where more adhesive is desired that would otherwise be required if the speed and flow rate were held constant. While speed and flow rate control can obviate the need to form these types of patterns, in some embodiments, any combination of patterning, speed control, and flow rate control can be used to vary the amount of adhesive dispensed at select locations of the contact surface.

Using one or more of the processes described above to vary the amount of adhesive dispensed at a particular location of the contact surface, a non-uniform pattern of adhesive can be applied to the first plate. In some embodiments, a greater amount of adhesive can be applied to the contact surface in regions likely to experience higher amounts of stress. For example, a rectangular plate, such as glass plate 123, can experience more stress at the corners when pressure is applied to the device. Thus, in these embodiments a greater volume of adhesive can be applied to the corners of the device to generate the non-uniform patterns shown and described above with respect to FIGS. 4 and 5. In other embodiments, as described above, the pattern of adhesive, and thus the amount of adhesive, applied to the contact surface can be determined based at least in part on the width of the contact surface at that particular location.

In some embodiments, an optical measurement device, such as a charge-coupled device (CCD) camera, can be used to provide feedback to a processor controlling the dispensing of adhesive. In these embodiments, the optical measurement device can measure a width of the adhesive being applied to the device and can provide this information to the processor controlling the dispensing of adhesive. Based on this information, the processor can adjust the amount and position of adhesive being dispensed to generate the desired adhesive pattern.

At block 605, a second plate can be positioned on the dispensed adhesive. In some embodiments, the contact surface of the second surface can be positioned on the adhesive applied to the contact surface of the first plate to form a seal along the contact surfaces. For example, the contact surface of a plate similar or identical to glass plate 127 can be applied to a contact surface similar or identical to contact surface 201 of glass plate 123 to form a seal along the contact surfaces. In other embodiments, the contact surface of a first electrode can be applied to a contact surface of a second electrode to form a seal along the contact surfaces.

In an alternate process, rather than forming a continuous pattern of adhesive, discrete segments of adhesive can be dispersed on the contact surface to form a broken pattern. Here, the nozzle can start and stop dispensing adhesive as it traverses the contact surface of the glass plate. In some embodiments, the dispensing time, i.e., the time between the start and stop, can be the same as the nozzle traverses the contact surface, allowing the nozzle speed, adhesive flow rate, or both vary to adjust the dispensed amounts of the discrete segments. In some embodiments, the dispensing time can vary based on the dispensing location on the contact surface as the nozzle traverses the contact surface, working in combination with the nozzle speed, adhesive flow rate, or both to adjust the dispensed amounts of the discrete segments.

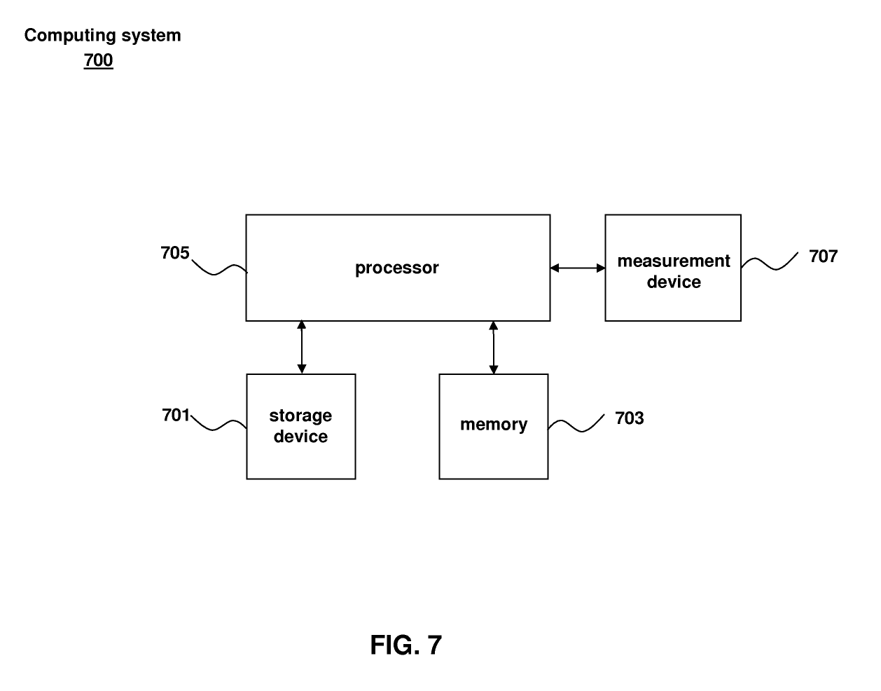

One or more of the functions relating to the dispensing of adhesive described above can be automated and, in some examples, be controlled by a computing system similar or identical to computing system 700 shown in FIG. 7. Computing system 700 can include instructions stored in a non-transitory computer readable storage medium, such as memory 703 or storage device 701, and executed by processor 705. The instructions can also be stored and/or transported within any non-transitory computer readable storage medium for use by or in connection with an instruction execution system, apparatus, or device, such as a computer-based system, processor-containing system, or other system that can fetch the instructions from the instruction execution system, apparatus, or device and execute the instructions. In the context of this document, a “non-transitory computer readable storage medium” can be any medium that can contain or store the program for use by or in connection with the instruction execution system, apparatus, or device. The non-transitory computer readable storage medium can include, but is not limited to, an electronic, magnetic, optical, electromagnetic, infrared, or semiconductor system, apparatus or device, a portable computer diskette (magnetic), a random access memory (RAM) (magnetic), a read-only memory (ROM) (magnetic), an erasable programmable read-only memory (EPROM) (magnetic), a portable optical disc such a CD, CD-R, CD-RW, DVD, DVD-R, or DVD-RW, or flash memory such as compact flash cards, secured digital cards, USB memory devices, memory sticks, and the like.

The instructions can also be propagated within any transport medium for use by or in connection with an instruction execution system, apparatus, or device, such as a computer-based system, processor-containing system, or other system that can fetch the instructions from the instruction execution system, apparatus, or device and execute the instructions. In the context of this document, a “transport medium” can be any medium that can communicate, propagate or transport the program for use by or in connection with the instruction execution system, apparatus, or device. The transport medium can include, but is not limited to, an electronic, magnetic, optical, electromagnetic or infrared wired or wireless propagation medium.

Computing system 700 can further include measurement device 707 coupled to processor 705. Measurement device 707 can include various optical measurement devices, such as a CCD camera. In some embodiments, measurement device 707 can be used to measure a width of an adhesive deposited on an object and provide the measurement to processor 705. Processor 705 can use the measurement to adjust the amount and position of adhesive deposited to generate a desired adhesive pattern in a manner similar or identical to that described above with respect to block 603 of process 600.

It is to be understood that the computing system is not limited to the components and configuration of FIG. 7, but can include other or additional components in multiple configurations according to various embodiments.

An OLED display or LCD panel having plates with a variable width seal as in FIGS. 4 and 5 can be incorporated into a mobile phone, a digital media player, a portable computer, and other suitable devices.

Although embodiments have been fully described with reference to the accompanying drawings, it is to be noted that various changes and modifications will become apparent to those skilled in the art. Such changes and modifications are to be understood as being included within the scope of the various embodiments as defined by the appended claims.

What is claimed is:

1. A method for generating a seal between a first plate and a second plate, the method comprising:
dispensing an adhesive material along a contact surface of the first plate;
varying at least one of a flow rate of the adhesive material or a speed of a dispenser of the adhesive material at a select location along the contact surface, the variation dependent on a width of the contact surface at the select location; and
positioning the second plate over the contact surface of the first plate and in contact with the dispensed adhesive material to form the seal.

2. The method of claim 1, wherein varying at least one of the flow rate or the speed comprises varying both the flow rate and the speed.

3. The method of claim 1, wherein varying at least one of the flow rate or the speed results in a volume of the adhesive material dispensed at the select location that is at least 100% more than a volume of the adhesive material dispensed at another location along the contact surface.

4. The method of claim 3, wherein the select location is a corner of the contact surface.

5. The method of claim 1, wherein varying at least one of the flow rate or the speed comprises increasing the flow rate at the select location or decreasing the speed at the select location.

6. A method for generating a seal between a first plate and a second plate, the method comprising:
dispensing an adhesive material along a contact surface of the first plate, wherein the contact surface represents a portion of the first plate that is to contact the second plate to form the seal, and wherein a volume of the adhesive material at a corner of the contact surface is larger than a volume of the adhesive material at an edge of the contact surface; and
positioning the second plate against the contact surface of the first plate to form the seal.

7. The method of claim 6, wherein the adhesive material is dispensed by an adhesive dispensing nozzle that traverses the contact surface of the first plate.

8. The method of claim 7, wherein a speed at which the adhesive dispensing nozzle traverses the contact surface of the first plate is reduced at the corner of the contact surface, and wherein a rate at which the adhesive material flows from the adhesive dispensing nozzle is increased at the corner of the contact surface.

9. The method of claim 6, wherein the adhesive material is dispensed along a center of the contact surface located at midpoints between an inner edge of the contact surface and an outer edge of the contact surface.

10. The method of claim 1, wherein varying at least one of the flow rate of the adhesive material or the speed of the dispenser of the adhesive material further depends on feedback from an optical measurement device.

11. A method for forming an adhesive seal on a plate, the method comprising:
dispensing, by an automated adhesive dispensing nozzle operable to vary a flow rate at which an adhesive material is dispensed and a speed at which the adhesive dispensing nozzle traverses the plate, variable amounts of the adhesive material along a perimeter of the plate, wherein the amounts are varied according to a width of a contact area along the perimeter of the plate at a given location on the perimeter of the plate; and
forming an adhesive seal having variable widths corresponding to the variable amounts of the dispensed adhesive material.

12. The method of claim 11, wherein the variable amounts of the adhesive material are dispensed on the plate in a continuous stream of adhesive material.

13. The method of claim 11, wherein the variable amounts of the adhesive material are dispensed on the plate in discrete segments of adhesive material.

14. The method of claim 11, wherein the automated adhesive dispensing nozzle is operable to dispense the adhesive material during discrete time periods.

15. The method of claim 14, wherein durations of the discrete time periods are either the same or different.

16. The method of claim 11, wherein the variable amounts of the adhesive material are dispensed by the adhesive dispensing nozzle in a single pass over the perimeter of the plate.

17. The method of claim 11, wherein the variable amounts of the adhesive material are dispensed by varying at least one of the flow rate at which the adhesive material is dispensed and the speed at which the adhesive dispensing nozzle traverses the plate.

18. An LCD panel comprising:
a first plate;
a second plate positioned against the first plate, wherein a first contact surface of the first plate contacts a second contact surface of the second plate;
a cavity formed between the first plate and the second plate;
liquid crystals disposed within the cavity formed between the first plate and the second plate; and
an adhesive material disposed between the first contact surface and the second contact surface, wherein a width of the adhesive material at a corner of the first and second contact surfaces is larger than a width of the adhesive material at an edge of the first and second contact surfaces.

19. The LCD panel of claim 18, wherein a distance between an edge of the adhesive material and an edge of the first and second contact surfaces is less than 200 μm.

20. The LCD panel of claim 18, wherein the adhesive material comprises a single continuous strip of adhesive.

21. The LCD panel of claim 18, wherein the adhesive material comprises discrete segments of adhesive.

22. An apparatus comprising:
a first plate;
a second plate positioned against the first plate, wherein a first contact surface of the first plate contacts a second contact surface of the second plate; and
an adhesive material disposed between the first contact surface and the second contact surface, wherein a width of the adhesive material at a corner of the first and second contact surfaces is larger than a width of the adhesive material at an edge of the first and second contact surfaces.

23. The apparatus of claim 22, wherein the width of the adhesive material at the corner of the first and second contact surfaces is at least 100% larger than the width of the adhesive material at the edge of the first and second contact surfaces.

24. The apparatus of claim 22 further comprising:
a cavity formed between the first plate and the second plate; and
liquid crystals disposed within the cavity formed between the first plate and the second plate.

25. The apparatus of claim 22 further comprising:
a cavity formed between the first plate and the second plate; and
organic material disposed within the cavity formed between the first plate and the second plate.
